(19) United States
(12) Patent Application Publication
(10) Pub. No.: US 2019/0184560 A1
(43) Pub. Date: Jun. 20, 2019

(54) A Trajectory Planning Method For Six Degree-of-Freedom Robots Taking Into Account of End Effector Motion Error

(71) Applicant: Beijing University of Technology, Beijing (CN)

(72) Inventors: Zhifeng Liu, Beijing (CN); Jingjing Xu, Beijing (CN); Congbin Yang, Beijing (CN); Yongsheng Zhao, Beijing (CN); Qiang Cheng, Beijing (CN); Yanhu Pei, Beijing (US)

(73) Assignee: Beijing University of Technology, Beijing (CN)

(21) Appl. No.: 16/311,189

(22) PCT Filed: Sep. 25, 2017
(86) PCT No.: PCT/CN2017/103078

§ 371 Date: Dec. 19, 2018

(30) Foreign Application Priority Data
Jan. 19, 2017 (CN) 201710047955.6

(51) Int. Cl. B25J 9/16

(52) U.S. Cl. CPC B25J 9/1664; B25J 9/1653; B25J 9/1605

(57) ABSTRACT

The invention discloses a trajectory planning method for six degree-of-freedom robots taking into account of end effector motion error. Specifically, the invention disclosed a method for precise planning of robot end effector continuous trajectory by combining the screw theory, the cubic spline interpolation algorithm, and particle swarm optimization algorithm. Firstly, the forward kinematics model and the inverse kinematics model of the robot is established based on the screw theory to simplify the calculation process; Cubic spline interpolation is used in joint space to ensure smooth motion; finally, the end effector tracking error is controlled within the required range with the number of key points as the variable, then take the time intervals as design variable, take the maximum angular velocity, angular acceleration and angular jerk of each joint as the constraint conditions, and use tracking error minimization as the optimization objective, to perform optimization of the trajectory, in order to obtain a planning trajectory with high planning efficiency, small tracking error and smooth motion.

### CROSS REFERENCE TO RELATED APPLICATION

This application is a national stage application of International application number PCT/CN2017/103078, filed Sep. 25, 2017, titled “A Trajectory Planning Method For Six Degree-of-Freedom Robots Taking Into Account of End Effector Motion Error”, which claims the priority benefit of Chinese Patent Application No. 201710047955.6, filed on Jan. 19, 2017, which is hereby incorporated by reference in its entirety.

### TECHNICAL FIELD

The invention discloses a trajectory planning method for six degree-of-freedom (DOF) robots taking into account of end effector motion error, and relates to the field of robot motion control. Specifically, the invention involves planning the continuous trajectory of robot end effector by combining the screw theory, the cubic spline interpolation algorithm, and particle swarm optimization algorithm to obtain the objectives of satisfying tracking accuracy requirement, improving planning efficiency, and acquiring smooth motion trajectory.

### BACKGROUND

As one foundation of robot control research, trajectory planning has an important influence on the robot's comprehensive motion performance. As far as the space planning is concerned, the planning method includes joint space planning and operation space planning. Joint space planning method refers to direct interpolating joint variables, and ultimately establishing the change curve of joint variables with time; however, because it is impossible to predict the trajectory change of the end effector in the process of motion, the joint space planning method is only applicable to simple, point-to-point operation task of the end effector. For operation tasks with continuous trajectory for the end effector, the operation space planning method is needed. Although this method can produce a high tracking accuracy for the notion trajectory, it cannot guarantee the stability of motion. In order to ensure the flexibility of motion on top of tracking the end effector trajectory, some scholars first select the key trajectory points in the operation space that can guarantee the end effector trajectory, subsequently calculate trajectory nodes in each joint space based on the inverse kinematics solution model, and subsequently carry out trajectory planning in the joint space, so as to ensure both the basic end effector trajectory and motion stability. In this kind of method, trajectory planning can only guarantee the position accuracy of key trajectory points, but the tracking error of continuous trajectory caused by joint interpolation is still uncontrollable.

In trajectory planning, the more the number of end effector key trajectory points, the more accurate the tracking can be; however, the more key trajectory points there are, the smaller the distances between the joint angles; and the smaller the distance will be, the harder it will be for interpolation algorithm to play a real role in smoothing the trajectory; moreover, the more times of inverse solution, the more complex the trajectory planning calculation becomes, thus reducing the planning efficiency. Secondly, interpolation algorithm not only affects the trajectory curve, but also key parameters (such as time interval) have a certain impact on the tracking accuracy. In order to improve the planning efficiency, this patent establishes the forward and inverse kinematics model based on the screw theory. Compared with the traditional D-H model, the method has the advantages of clear geometric meaning, no singularity, and small computation load. In order to obtain a smooth motion, a cubic spline interpolation algorithm is adopted for joint space trajectory planning, and the angular velocity and angular acceleration obtained by this method are continuous. To minimize the tracking error under the condition of satisfying all requirements, particle swarm optimization algorithm is adopted to optimize the trajectory, which can reduce the tracking error by a combination of obtaining a reasonable number N of key trajectory points and obtaining an appropriate time intervals.

### SUMMARY

The invention discloses a trajectory planning method for six degree-of-freedom (DOF) robots taking into account of end effector motion error. In the method, key trajectory points are obtained at equal intervals of an end effector continuous trajectory; interpolation programming is carried out for the angular positions of each joint obtained by inverse solution of the screw-based kinematics model; at first, take the number of the key trajectory points as variable to control an end effector tracking error within a required range, then take the intervals as design variables, and take maximum angular velocity, angular acceleration and angular jerk of each joint as constraint conditions, take minimum tracking error as the optimization objective to optimize the trajectory so as to obtain the planned trajectory with high planning efficiency, small tracking error and smooth movement.

The invention is realized by the following technical means:

Step (1), a forward and an inverse kinematics model are established for the robot based on screw theory;

Step (2), on the end effector continuous trajectory, take N+1 key trajectory points at equal interval and get N track segments, with N representing the number of track segments; trajectory nodes of each joint are obtained by the inverse kinematics model, a cubic modified spline curve was used for interpolation programming to obtain time-related curves of angular displacement, angular velocity, angular acceleration and angular jerk;

Step (3), the tracking error model is established by taking points on the angular displacement curve every 20 milliseconds (ms) and calculating the end effector position through the forward kinematics model; the tracking errors of the end effector position points are calculated; a maximum tracking error max(Eₘ) was extracted, Eₘ is track tracking error, m is the number of joint node groups;

Step (4), Tₙ represents a time interval of the track segment n, take Tₙ=t, 1≤n≤N, plan the trajectory and calculate the maximum tracking error max(Eₘ) following the above steps; if the accuracy requirement max(Eₘ)<Eₘₐₓ is not met, Eₘₐₓ being the maximum tracking error defined according to the operation task, take N+1, and then calculate the error again, loop the calculation until the tracking error meets the condition; time interval t and motion accuracy limit Eₘₐₓ are determined according to specific task requirements; and

Step (5), when N is determined, taking the time intervals as the design variable, the angular velocity, angular acceleration and angular jerk of each joints as constraints, and the minimum tracking error as the optimization objective to optimize the trajectory and obtain an optimized trajectory.

The characteristic of the invention is: a trajectory planning method for six degree-of-freedom robots taking into accounts of end effector motion error, wherein: key trajectory points are obtained at equal intervals of an end effector continuous trajectory; interpolation programming is carried out for the angular positions of each joint obtained by inverse solution of the spinor kinematics model; at first, take the number of the key trajectory points as variable to control an end effector tracking error within a required range, then take the intervals as design variables, and take maximum angular velocity, angular acceleration and angular jerk of each joint as constraint conditions, take minimum tracking error as the optimization objective to optimize the trajectory so as to obtain the planned trajectory with high planning efficiency, small tracking error and smooth movement.

### BRIEF DESCRIPTION OF THE DRAWINGS

FIG. 1 is a diagram showing robots end effector trajectory planning flow chart.

FIG. 2 is a diagram showing parametric coordinates of a six DOF industrial robot.

FIGS. 3A, 3B, and 3C are diagrams showing the angular velocity, angular acceleration and angular jerk curves of each joints, respectively

FIG. 4 is a diagram showing the end effector tracking error curve.

### DETAILED DESCRIPTION OF THE PREFERRED EMBODIMENTS

### Embodiment I

Overall steps of the current disclosure are shown in FIG. 1.

Step (1), establishing a forward kinematics model and an inverse kinematics model for the robot based on screw theory.

The forward kinematics model:

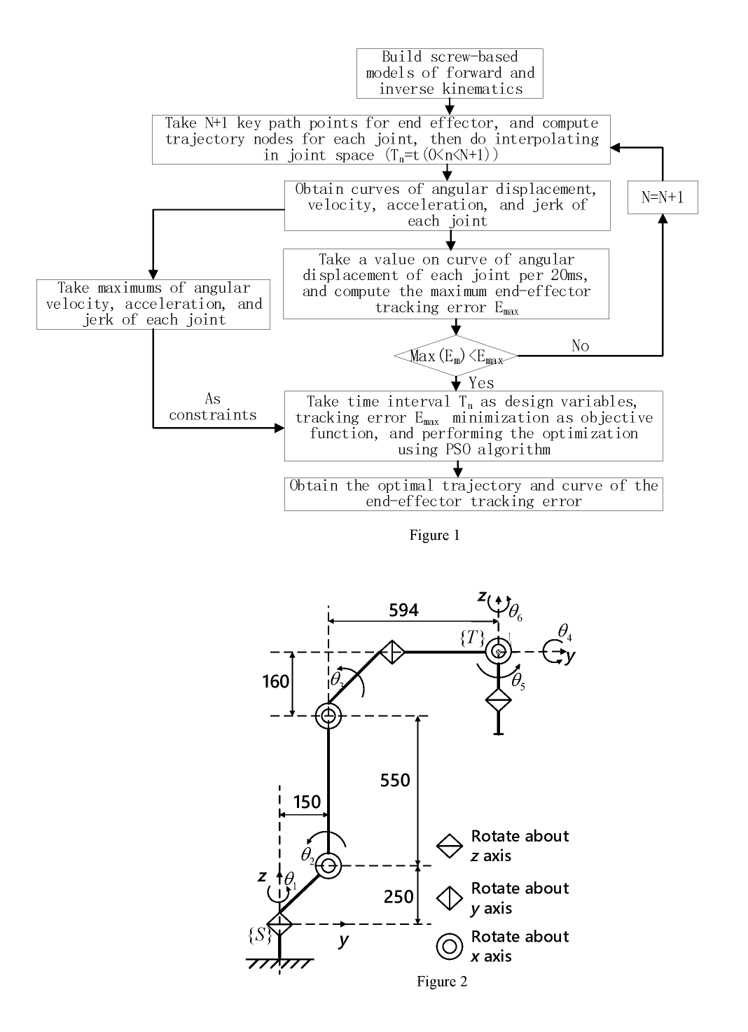

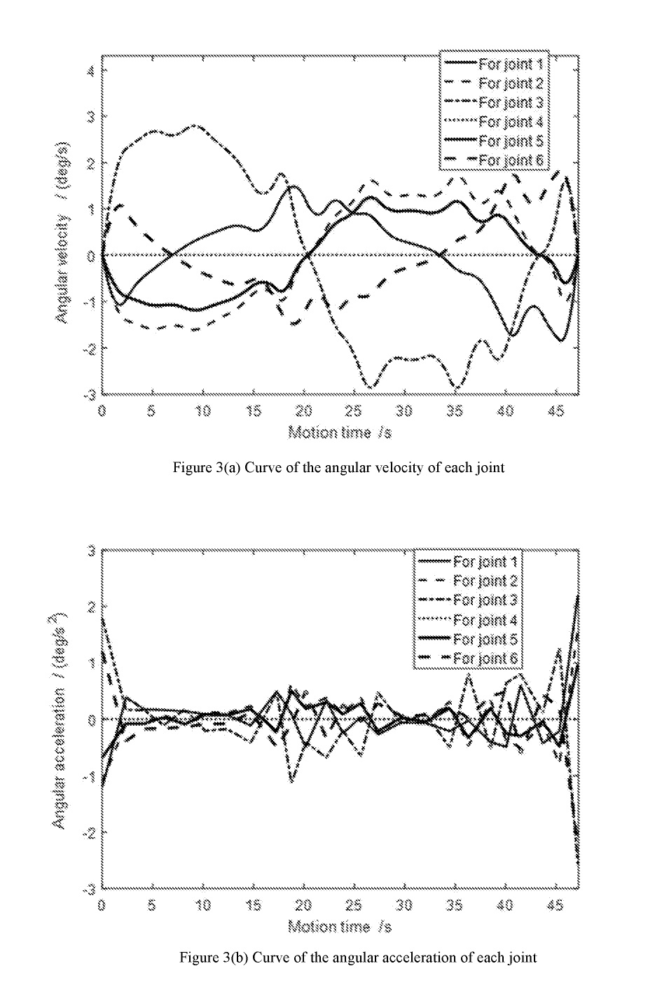

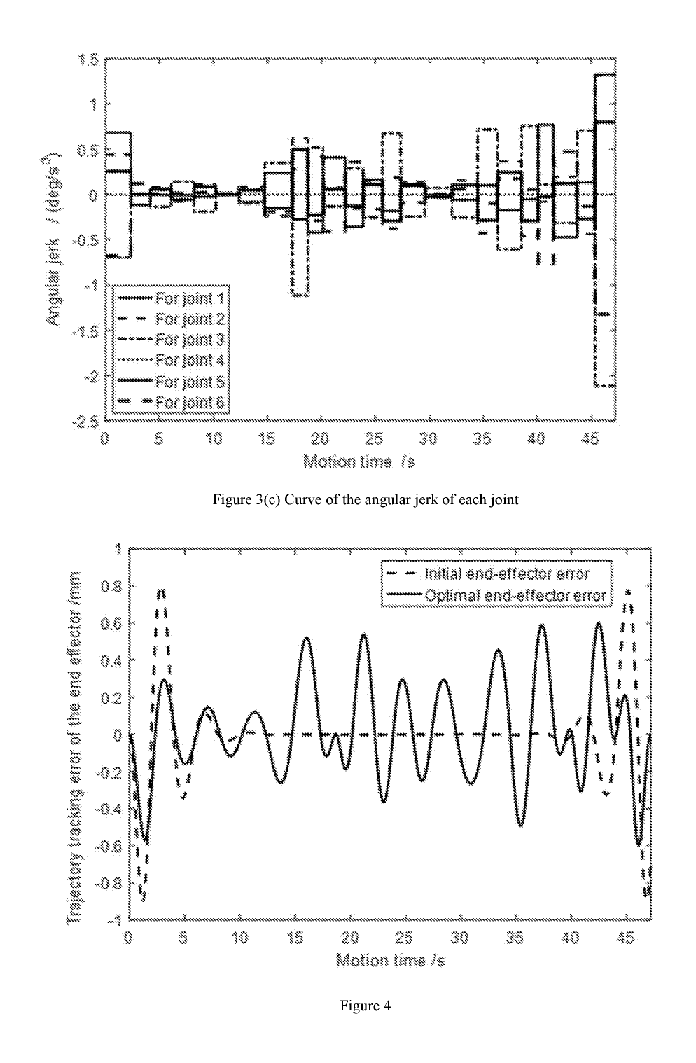

As shown in FIG. 2, the position vector rᵢ and rotation vector ωᵢ of the No. i joint in the initial state of the robot are known as follows:

r₁=[0 0 0] r₂=[0 150 250] r₃=[0 150 800] r₄=r₅=r₆=[0 744 940] (1)

ω₁=[0 0 1] ω₂=[1 0 0] ω₃=[1 0 0] ω₄=[0 1 0] ω₅=[1 0 0] ω₆=[0 0 1] (2)

based on screw theory, the transformation matrix between joints can be expressed in exponential form:

$$exp ( {\hat{ξ}}_{i} {θ}_{i} ) = [ \begin{matrix}exp ( {\hat{ω}}_{i} {θ}_{i} ) & ( I - exp ( {\hat{ω}}_{i} {θ}_{i} ) ) ( {ω}_{i} \times {v}_{i} ) + {θω}_{i} {ω}_{i}^{T} {v}_{i} \\ 0 & 1\end{matrix} ] \qquad ( 3 )$$

wherein \hat{ξ}ᵢ represents No. i joint spinor, θᵢ is the No. i angular displacement of joint;
\hat{ω}ᵢ is defined as

$$\hat{ω} = [ \begin{matrix}0 & - {ω}_{3} & {ω}_{2} \\ {ω}_{3} & 0 & - {ω}_{1} \\ - {ω}_{2} & {ω}_{1} & 0\end{matrix} ]$$

by ωᵢ=[ω₁ ω₂ ω₃]; so that
exp(\hat{ω}ᵢθᵢ)=I+\hat{ω}ᵢ sin θᵢ+\hat{ω}ᵢ²(1−cos θᵢ); vᵢ is the rotational linear velocity of No. i joint motion, vᵢ=−ωᵢ×rᵢ;
   the forward kinematics model gₛₜ(θ) of the robot can be expressed as follows:

gₛₜ(θ)=exp(\hat{ξ}₁θ₁)exp(\hat{ξ}₂θ₂) . . . exp(\hat{ξ}₆θ₆)gₛₜ(0) (4)

The inverse kinematics model:

the solution of joint angles is transformed into three Paden-Kahan subproblems; since the position of the robot end effector depends on joint 1, 2 and 3, and the robot's posture depends on joint 4, 5 and 6; first describe the inverse motion of the first three joints as: end position vector rₑ around the joint 1 to rotate −θ₁ to rₑ₁, then around the joint 2 to rotate −θ₂ to rₑ₂, then around the joint 3 to rotate −θ₃ to r₅, so that θ₁, θ₂ and θ₃ are carried out by the following three expressions, wherein, equation (5) belongs to subproblem 1, while equations (6) and (7) belong to subproblem 3

exp(\hat{ξ}₁θ₁)rₑ₁=rₑ (5)

∥rₑ₂−exp(\hat{ξ}₂θ₂)rₑ₁∥=δ₂ (6)

∥rₑ−exp(\hat{ξ}₃θ₃)rₑ₂∥=δ₃ (7)

wherein rₑ₁ is determined by end effector position vector rₑ=[x y z]; rₑ₁=[0 ±\sqrt{x²+y²} z], δ₂, δ₃ is determined distance, δ₂=∥rₑ₁−r₂∥, δ₃=∥rₑ−r₃∥;
next, θ₄, θ₅ and θ₆ are carried out by the following three expressions, wherein, equation (8) belongs to subproblem 2 and equation (9) belongs to subproblem 1

exp(\hat{ξ}₄θ₄) exp(\hat{ξ}₅θ₅)r₀₄=g₁r₀₄ (8)

exp(\hat{ξ}₆θ₆)r₀₆=g₂r₀₆ (9)

where r₀₄ is on rotation axis 6, not on rotation axis 4 and 5, take r₀₄=[0 744 0]; r₀₆ is not on rotation axis 6, take r₀₆=[0 150 860];

g₁=[exp(\hat{ξ}₁θ₁) exp(\hat{ξ}₂θ₂) exp(\hat{ξ}₃θ₃)]⁻¹gₛₜ(θ)gₛₜ(0)⁻¹;

g₂=[exp(\hat{ξ}₄θ₄) exp(\hat{ξ}₅θ₅)]⁻¹g₁;

Step (2), obtaining and interpolating the trajectory nodes of each joint, is performed as follows:

The continuous trajectory curve of the end effector is defined as follows, whose posture is maintained as Ω=[0 0 1], and the total operation task time T is no greater than 1 minute:

$$\{ \begin{matrix}x = - 850 + 150 cos α \\ y = 500 + 150 sin α \\ z = 300\end{matrix} \qquad ( 10 )$$

where 0≤α≤360°, in order to take N+1 key trajectory points with equal interval, take α=(360n/N)°, n=0,1,2, . . . N;

The obtained end effector posture is substituted into the inverse kinematics model to obtain N+1 joint trajectory nodes; a cubic modified spline curve is used to interpolate the joint trajectory nodes; for a joint, the joint trajectory is divided into N subsegments, angular displacement Sₙ(t), angular velocity Sₙ′(t), angular acceleration Sₙ″(t) of the No. n subsegments (t ∈ [tₙ₋₁, tₙ]) trajectory can be expressed as follows:

$$\begin{matrix}{S}_{n} ( t ) = \frac{{( {t}_{n} - t )}^{3}}{6 {T}_{n}} {\ddot{θ}}_{n - 1} + \frac{{( t - {t}_{n - 1} )}^{3}}{6 {T}_{n}} {\ddot{θ}}_{n} + ( {θ}_{n - 1} - \frac{{\ddot{θ}}_{n - 1} {T}_{n}^{2}}{6} ) \frac{{t}_{n} - t}{{T}_{n}} + ( {θ}_{n} - \frac{{\ddot{θ}}_{n} {T}_{n}^{2}}{6} ) \frac{t - {t}_{n - 1}}{{T}_{n}} & ( 11 ) \\ {S}_{n}^{′} ( t ) = \frac{1}{2 {T}_{n}} [ ( {\ddot{θ}}_{n} - {\ddot{θ}}_{n - 1} ) {t}^{2} - 2 ( {\ddot{θ}}_{n} {t}_{n - 1} - {\ddot{θ}}_{n - 1} {t}_{n} ) t + {\ddot{θ}}_{n} {t}_{n - 1}^{2} - {\ddot{θ}}_{n - 1} {t}_{n}^{2} ] + \frac{{θ}_{n} - {θ}_{n - 1}}{{T}_{n}} - \frac{{\ddot{θ}}_{n} - {\ddot{θ}}_{n - 1}}{6} {T}_{n} & ( 12 ) \\ {S}_{n}^{″} ( t ) = \frac{{t}_{n} - t}{{T}_{n}} {\ddot{θ}}_{n - 1} + \frac{t - {t}_{n - 1}}{{T}_{n}} {\ddot{θ}}_{n} & ( 13 )\end{matrix}$$

wherein Tₙ is the interval of the No. n subsegments; θₙ, \dot{θ}ₙ, \ddot{θ}ₙ is angular displacement, angular velocity and angular acceleration of the joint corresponding to time tₙ, \ddot{θ}ₙ is calculated by boundary conditions Sₙ(tₙ₋₁)=θₙ₋₁, Sₙ(tₙ)=θₙ and Sₙ′(tₙ)=Sₙ₊₁′(tₙ);

Step (3), establishing the end effector tracking error model, is performed as follows:

The obtained angular displacement curves of each joint are evaluated every 20 ms to obtain M=T/0.02 sets of joint node groups, and calculating the corresponding terminal posture of each node group through the forward kinematics model as follows:

gₘ=exp(\hat{ξ}₁θ₁ₘ) exp(\hat{ξ}₂θ₂ₘ) . . . exp(\hat{ξ}₆θ₆ₘ)gₛₜ(0) (14)

wherein θ₁ₘ . . . θ₆ₘ is the No. m joint node group; the corresponding position vector Pₘ in gₘ is extracted and the end effector error model Eₘ was established as follows,

Eₘ=∥Pₘ−O∥−R (15)

wherein O is the position vector of the center of the trajectory circle, R is the radius of curvature at each point on the continuous trajectory, R=150 mm;

Step (4), determining the number of end key trajectory points n, is performed as follows:

take Tₙ=2, trajectory planning for each joint is carried out according to the step 2 for the end effector, solving the end effector maximum error value max(Eₘ); the task requires the end effector error to meet the following conditions: max(Eₘ)≤Eₘₐₓ=1 mm, if the calculation results do not meet the task requirements, increase the number of trajectory point N, continue to plan and calculate the end effector error, and continue the loop of calculation until the end effector tracking accuracy requirements are met, so as to determine N=24.

Step (5), optimizing the trajectory with minimizing end effector motion error as the objective function, is performed as follows:

obtain the maximum values of the angular velocity, the angular acceleration and the angular jerk of each joint through the step (2) as follows:

S′ₘₐₓ=max(|{S′ₙ(t), 1≤n≤24}|) (19)

S″ₘₐₓ=max(|{S″ₙ(t), 1≤n≤24}|) (20)

S′″ₘₐₓ=max(|{S′″ₙ(t), 1≤n≤24}|) (21)

so that the optimization constraint conditions is expressed as follows:

$$\{ \begin{matrix}1 \leq {T}_{n} \leq 3 \\ {S}_{max i}^{′} \leq {\dot{θ}}_{max i} \\ {S}_{max i}^{″} \leq {\ddot{θ}}_{max i} \\ {S}_{max i}^{′′′} \leq {{θ}^{...}}_{max i}\end{matrix} \qquad ( 22 )$$

wherein the range of time interval Tₙ is determined according to a specific task, \dot{θ}_{max i}, \ddot{θ}_{max i}, and [symbol] _{max i} are the maximum angular velocity, angular acceleration and angular jerk allowed by No. i joint, and the objective optimization function is expressed as,

ƒ=min(Eₘₐₓ) (23)

What is claimed is:

1. A trajectory planning method for six degree-of-freedom robots taking into accounts of end effector motion error, wherein: key trajectory points are obtained at equal interval of an end effector continuous trajectory; interpolation programming is carried out for the angular positions of each joint obtained by inverse solution of the spinor kinematics model; at first, take the number of the key trajectory points as variable to control an end effector tracking error within a required range, then take the intervals as design variables, and take maximum angular velocity, angular acceleration and angular jerk of each joint as constraint conditions, take minimum tracking error as the optimization objective to optimize the trajectory so as to obtain the planned trajectory with high planning efficiency, small tracking error and smooth movement; comprising the steps of:
step (1), a forward and an inverse kinematics model are established for the robot based on screw theory;
step (2), on the end effector continuous trajectory, take N+1 key trajectory points at equal interval and get N track segments, with N representing the number of track segments; trajectory nodes of each joint are obtained by the inverse kinematics model, a cubic modified spline curve was used for interpolation programming to obtain time-related curves of angular displacement, angular velocity, angular acceleration and angular jerk;
step (3), the tracking error model is established by taking points on the angular displacement curve every 20 milliseconds (ms) and calculating the end effector position through the forward kinematics model; the tracking errors of the end effector position points are calculated; a maximum tracking error max(Eₘ) was extracted, Eₘ is track tracking error, m is the number of joint node groups;
step (4), Tₙ represents a time interval of the track segment n, take Tₙ=t, 1≤n≤N, plan the trajectory and calculate the maximum tracking error max(Eₘ) following the above steps; if the accuracy requirement max(Eₘ)<Eₘₐₓ is not met, Eₘₐₓ being the maximum tracking error defined according to the operation task, take N+1, and then calculate the error again, loop the calculation until the tracking error meets the condition; time interval t and motion accuracy limit Eₘₐₓ are determined according to specific task requirements; and
step (5), when N is determined, taking the time intervals as the design variable, the angular velocity, angular acceleration and angular jerk of each joints as constraints, and the minimum tracking error as the optimization objective to optimize the trajectory and obtain an optimized trajectory.

2. A trajectory planning method for six degree-of-freedom robots taking into accounts of end effector motion error according to claim 1,
wherein, the forward and the inverse kinematics model in step (1) are established as follows:
for the forward kinematics model:
the position vector rᵢ and rotation vector ωᵢ of the No. i joint in the initial state of the robot are known as follows:
r₁=[0 0 0] r₂=[0 150 250] r₃=[0 150 800] r₄=r₅=r₆=[0 744 940] (1)
ω₁=[0 0 1] ω₂=[1 0 0] ω₃=[1 0 0] ω₄=[0 1 0] ω₅=[1 0 0] ω₆=[0 0 1] (2)
based on screw theory, the transformation matrix between joints is expressed in exponential form:
$$exp ( {\hat{ξ}}_{i} {θ}_{i} ) = [ \begin{matrix}exp ( {\hat{ω}}_{i} {θ}_{i} ) & ( I - exp ( {\hat{ω}}_{i} {θ}_{i} ) ) ( {ω}_{i} \times {v}_{i} ) + {θω}_{i} {ω}_{i}^{T} {v}_{i} \\ 0 & 1\end{matrix} ] \qquad ( 3 )$$
wherein \hat{ξ}ᵢ represents No. i joint spinor, θᵢ is the No. i angular displacement of joint;
\hat{θ}ᵢ is defined as
$$\hat{ω} = [ \begin{matrix}0 & - {ω}_{3} & {ω}_{2} \\ {ω}_{3} & 0 & - {ω}_{1} \\ - {ω}_{2} & {ω}_{1} & 0\end{matrix} ]$$
by ωᵢ=[ω₁ ω₂ ω₃]; so that
exp(\hat{ω}ᵢθᵢ)=I+\hat{ω}ᵢ sin θᵢ+\hat{ω}ᵢ²(1−cos θᵢ); vᵢ is the rotational linear velocity of No. i joint motion, vᵢ=−ωᵢ×rᵢ;
the forward kinematics model gₛₜ(θ) of the robot is expressed as follows:
gₛₜ(θ)=exp(\hat{ξ}₁θ₁) exp(\hat{ξ}₂θ₂) . . . exp(\hat{ξ}₆θ₆)gₛₜ(0) (4)
for inverse kinematics model:
the solution of joint angles is transformed into three Paden-Kahan subproblems; since the position of the robot end effector depends on joint 1, 2 and 3, and the robot's posture depends on joint 4, 5 and 6; first describe the inverse motion of the first three joints as: end position vector rₑ around the joint 1 to rotate −θ₁ to rₑ₁, then around the joint 2 to rotate −θ₂ to rₑ₂, then around the joint 3 to rotate −θ₃ to r₅, so that θ₁, θ₂ and θ₃ are carried out by the following three expressions, wherein, equation (5) belongs to subproblem 1, while equations (6) and (7) belong to subproblem 3
exp(\hat{ξ}₁θ₁)rₑ₁=rₑ (5)
∥rₑ₂−exp(\hat{ξ}₂θ₂)rₑ₁∥=δ₂ (6)
∥rₑ−exp(\hat{ξ}₃θ₃)rₑ₂∥=δ₃ (7)
wherein rₑ₁ is determined by end effector position vector rₑ=[x y z]; rₑ₁=[0 ±\sqrt{x²+y²} z], δ₂, δ₃ is determined distance, δ₂=∥rₑ₁−r₂∥, δ₃=∥rₑ−r₃∥;
next, θ₄, θ₅ and θ₆ are carried out by the following three expressions, wherein, equation (8) belongs to subproblem 2 and equation (9) belongs to subproblem 1
exp(\hat{ξ}₄θ₄) exp(\hat{ξ}₅θ₅)r₀₄=g₁r₀₄ (8)
exp(\hat{ξ}₆θ₆)r₀₆=g₂r₀₆ (9)
where r₀₄ is on rotation axis 6, not on rotation axis 4 and 5, take r₀₄=[0 744 0]; r₀₆ is not on rotation axis 6, take r₀₆=[0 150 860];
g₁=[exp(\hat{ξ}₁θ₁) exp(\hat{ξ}₂θ₂) exp(\hat{ξ}₃θ₃)]⁻¹gₛₜ(θ)gₛₜ(0)⁻¹;
g₂=[exp(\hat{ξ}₄θ₄) exp(\hat{ξ}₅θ₅)]⁻¹g₁;
wherein the step (2) of claim 1, obtaining and interpolating the trajectory nodes of each joint, is performed as follows:
the continuous trajectory curve of the end effector is defined as follows, whose posture is maintained as Ω=[0 0 1], and the total operation task time T is not greater than 1 minutes;
$$\{ \begin{matrix}x = - 850 + 150 cos α \\ y = 500 + 150 sin α \\ z = 300\end{matrix} \qquad ( 10 )$$
where 0≤α≤360°, in order to take N+1 key trajectory points with equal interval, take α=(360n/N)°, n=0,1, 2, . . . N;
the obtained end posture is substituted into the inverse kinematics model to obtain N+1 joint trajectory nodes; a cubic modified spline curve is used to interpolate the joint trajectory nodes; for a joint, the joint trajectory is divided into N subsegments, angular displacement Sₙ(t), angular velocity S′ₙ(t), angular acceleration S″ₙ(t) of the No. n subsegments (t ∈ [tₙ₋₁, tₙ]) trajectory can be expressed as follows:
$$\begin{matrix}{S}_{n} ( t ) = \frac{{( {t}_{n} - t )}^{3}}{6 {T}_{n}} {\ddot{θ}}_{n - 1} + \frac{{( t - {t}_{n - 1} )}^{3}}{6 {T}_{n}} {\ddot{θ}}_{n} + ( {θ}_{n - 1} - \frac{{\ddot{θ}}_{n - 1} {T}_{n}^{2}}{6} ) \frac{{t}_{n} - t}{{T}_{n}} + ( {θ}_{n} - \frac{{\ddot{θ}}_{n} {T}_{n}^{2}}{6} ) \frac{t - {t}_{n - 1}}{{T}_{n}} & ( 11 ) \\ {S}_{n}^{′} ( t ) = \frac{1}{2 {T}_{n}} [ ( {\ddot{θ}}_{n} - {\ddot{θ}}_{n - 1} ) {t}^{2} - 2 ( {\ddot{θ}}_{n} {t}_{n - 1} - {\ddot{θ}}_{n - 1} {t}_{n} ) t + {\ddot{θ}}_{n} {t}_{n - 1}^{2} - {\ddot{θ}}_{n - 1} {t}_{n}^{2} ] + \frac{{θ}_{n} - {θ}_{n - 1}}{{T}_{n}} - \frac{{\ddot{θ}}_{n} - {\ddot{θ}}_{n - 1}}{6} {T}_{n} & ( 12 ) \\ {S}_{n}^{″} ( t ) = \frac{{t}_{n} - t}{{T}_{n}} {\ddot{θ}}_{n - 1} + \frac{t - {t}_{n - 1}}{{T}_{n}} {\ddot{θ}}_{n} & ( 13 )\end{matrix}$$
wherein Tₙ is the interval of the No. n subsegments; θₙ, \dot{θ}ₙ, \ddot{θ}ₙ is angular displacement, angular velocity and angular acceleration of the joint corresponding to time tₙ, \ddot{θ}ₑ is calculated by boundary conditions Sₙ(tₙ₋₁)=θₙ₋₁, Sₙ(tₙ)=θₙ and S′ₙ(tₙ)=S′ₙ₊₁(tₙ);
wherein the step (3) of claim 1, establishing the end effector tracking error model, is performed as follows:
the obtained angular displacement curves of each joint are evaluated every 20 ms to obtain M=T/0.02 sets of joint node groups, and calculating the corresponding terminal posture of each node group through the forward kinematics model as follows:
gₘ=exp(\hat{ξ}₁θ₁ₘ) exp(\hat{ξ}₂θ₂ₘ) . . . exp(\hat{ξ}₆θ₆ₘ)gₛₜ(0) (14)
wherein θ₁ₘ . . . θ₆ₘ is the No. m joint node group; the corresponding position vector Pₘ in gₘ is extracted and the end effector error model Eₘ was established as follows,
Eₘ=∥Pₘ−O∥−R (15)
wherein O is the position vector of the center of the trajectory circle, R is the radius of curvature at each point on the continuous trajectory, R=150 mm;
wherein the step (4) of claim 1, determining the number of end key trajectory points n, is performed as follows:
take Tₙ=2, trajectory planning for each joint is carried out according to the step 2 for the end effector, solving the end effector maximum error value max(Eₘ); the task requires the end effector error to meet the following conditions: max(Eₘ)≤Eₘₐₓ=1 mm, if the calculation results do not meet the task requirements, increase the number of trajectory point N, continue to plan and calculate the end effector error, and continue the loop of calculation until the end effector tracking accuracy requirements are met, so as to determine N=24;
wherein the step (5) of claim 1, optimizing the trajectory with minimizing end effector motion error as the objective function, is performed as follows:
obtain the maximum values of the angular velocity, the angular acceleration and the angular jerk of each joint through the step (2) as follows:
S′ₘₐₓ=max(|{S′ₙ(t), 1≤n≤24}|) (19)
S″ₘₐₓ=max(|{S″ₙ(t), 1≤n≤24}|) (20)
S′″ₘₐₓ=max(|{S′″ₙ(t), 1≤n≤24}|) (21)
so that the optimization constraint conditions is expressed as follows:
$$\{ \begin{matrix}1 \leq {T}_{n} \leq 3 \\ {S}_{max i}^{′} \leq {\dot{θ}}_{max i} \\ {S}_{max i}^{″} \leq {\ddot{θ}}_{max i} \\ {S}_{max i}^{′′′} \leq {{θ}^{...}}_{max i}\end{matrix} \qquad ( 22 )$$
wherein the range of time interval Tₙ is determined according to a specific task, \dot{θ}_{max i}, \ddot{θ}_{max i}, and [symbol] _{max i} are the maximum angular velocity, angular acceleration and angular jerk allowed by No. i joint, and the objective optimization function is expressed as,
ƒ=min(Eₘₐₓ) (23)
